(19) United States
(12) Patent Application Publication
(10) Pub. No.: US 2016/0260540 A1
(43) Pub. Date: Sep. 8, 2016

(54) BOBBIN STRUCTURE

(71) Applicants: LITE-ON ELECTRONICS (GUANGZHOU) LIMITED, Guangzhou (CN); LITE-ON TECHNOLOGY CORP., Taipei (TW)

(72) Inventors: WEI-LIEH LAI, Taipei (TW); WEN-LUNG LIANG, Taipei City (TW); YU-HSIANG LEE, Taipei City (TW); YI-PIN LEE, Taipei (TW)

(21) Appl. No.: 14/746,962

(22) Filed: Jun. 23, 2015

(30) Foreign Application Priority Data
Mar. 6, 2015 (CN) 201520130562.8

(51) Int. Cl. H01F 27/32

(52) U.S. Cl. CPC H01F 27/325

(57) ABSTRACT

A bobbin structure includes a hollow cylindrical body, a first blocking member extending outward from one end of the cylindrical body, a second blocking member extending outward from another end of the cylindrical body that is opposite to the one end, and a ring sleeved onto the cylindrical body between the first and second blocking members and movable relative to the cylindrical body for repositioning.

### CROSS-REFERENCE TO RELATED APPLICATION

This application claims priority of Chinese Patent Application No. 201520130562.8, filed on Mar. 6, 2015.

### FIELD

The disclosure relates to a bobbin, and more particularly to a bobbin structure for a coil of a transformer or an inductor to be wound thereon.

### BACKGROUND

The most important factor/element of a power supply is power conversion efficiency, thus, when designing a power supply, the number of components used should be minimized. Therefore, when designing the inductor or transformer, to avoid its magnetic core's flux density from reaching a value of saturation, an air gap is designed in the magnetic core to increase the flux density margin and to prevent the magnetic core from suddenly reaching its saturation state. However, the air gap causes magnetic lines of force that are generated by the magnetic core to expand outward, resulting in magnetic flux leakage. The winding (coil) that is wound on a bobbin structure and that is proximate to the air gap interlinks with the magnetic flux leakage, thereby causing eddy current loss in the winding.

### SUMMARY

Therefore, an object of the disclosure is to provide a bobbin structure that can effectively minimize eddy current loss in winding. According to the disclosure, the bobbin structure includes a hollow cylindrical body configured for a magnetic core to be disposed thereon and for a coil to wind thereon, a first blocking member extending outward from one end of the cylindrical body, a second blocking member extending outward from another end of the cylindrical body that is opposite to the one end, and a ring sleeved onto the cylindrical body between the first and second blocking members and movable relative to the cylindrical body for repositioning.

### BRIEF DESCRIPTION OF THE DRAWINGS

Other features and advantages of the disclosure will become apparent in the following detailed description of the embodiments with reference to the accompanying drawings, of which:

FIG. 1 is an exploded perspective view illustrating a first embodiment of a bobbin structure according to the disclosure;

FIG. 2 is an assembled perspective view of FIG. 1;

FIG. 3 is an exploded perspective view of the bobbin structure of the first embodiment and a magnetic core;

FIG. 4 is an assembled perspective view of FIG. 3;

FIG. 5 is a sectional side view taken along line V-V of FIG. 4;

FIG. 6 is a perspective view of an alternative form of a ring of the first embodiment;

FIG. 7 is a perspective view of another alternative form of the ring of the first embodiment; and

FIG. 8 is an exploded perspective view illustrating a second embodiment of a bobbin structure according to the disclosure.

### DETAILED DESCRIPTION

Before the disclosure is described in greater detail, it should be noted that like elements are denoted by the same reference numerals throughout the disclosure.

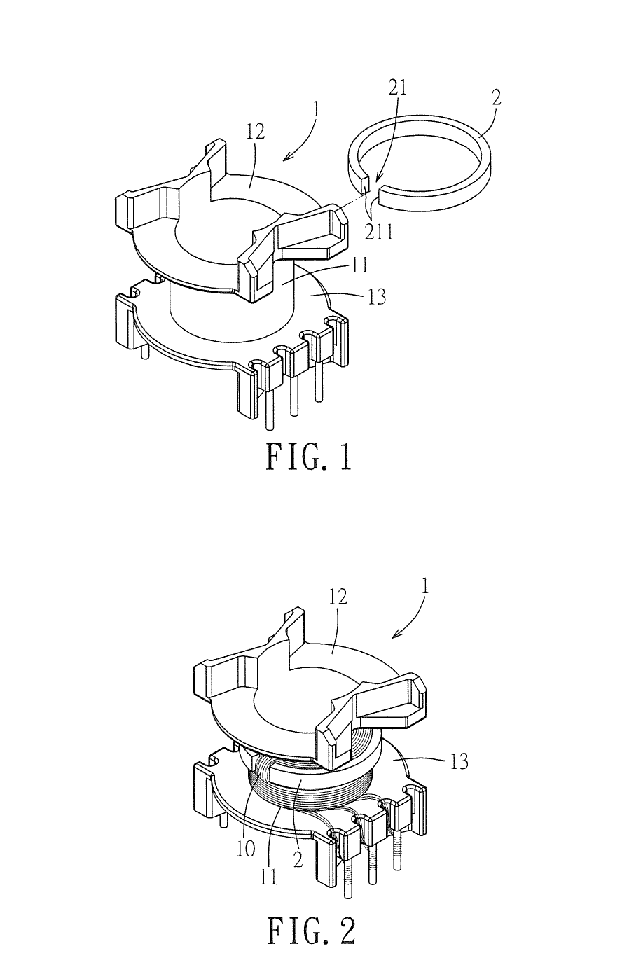

Referring to FIG. 1, a first embodiment of a bobbin structure 1 according to the disclosure includes a hollow cylindrical body 11, a first blocking member 12, a second blocking member 13, and a ring 2.

The first blocking member 12 extends outwardly and radially from one end of the cylindrical body 11. The second blocking member 13 extends outwardly and radially from another end of the cylindrical body 11 that is opposite to the one end. The cylindrical body 11 is formed with a through hole 14 that extends from one end to another end thereof. The ring 2 is a flexible C-shaped ring, and is formed with a gap 21. In use, the gap 21 of the ring 2 is aligned with the cylindrical body 11, and the ring 2 is then stretched for expanding the gap 21 to match the width of the cylindrical body 11 for the ring 2 to be fitly and detachably sleeved thereon. Further, an appropriate force can be applied to the ring 2, so that the ring 2 is movable relative to the cylindrical body 11 between the first and second blocking members 12, 13 for repositioning.

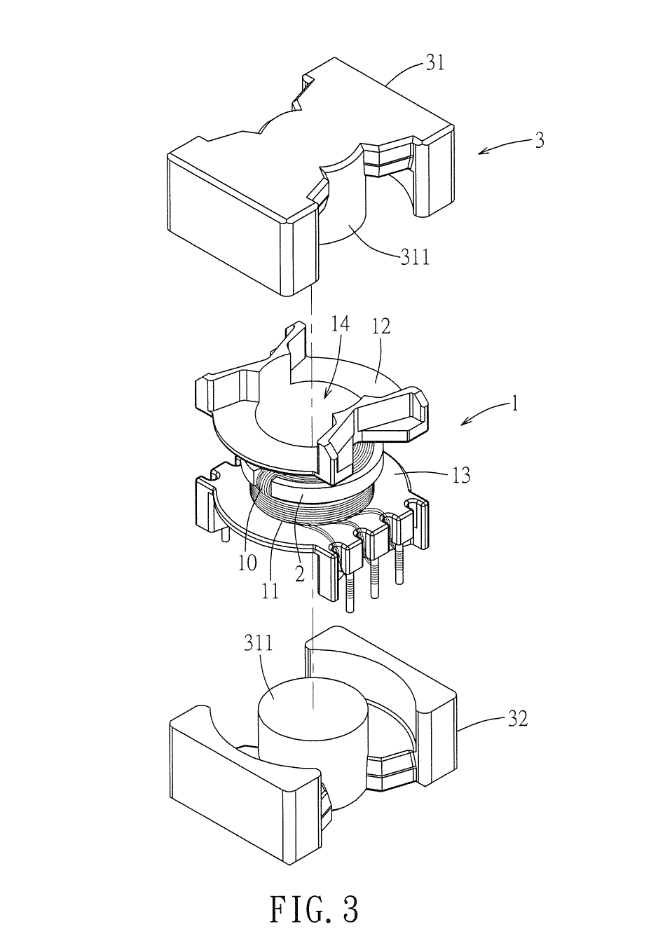

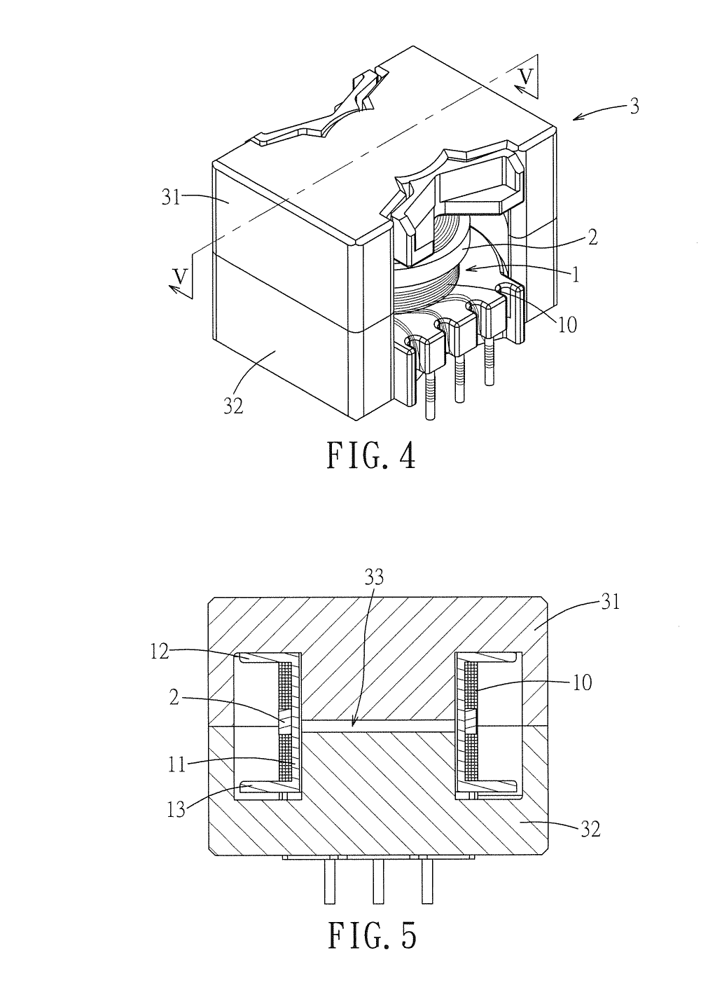

Referring to FIG. 2, the cylindrical body 11 is configured for a coil 10 to wind thereon, and the wire of the coil 10 may pass through the ring 2 via the gap 21 and wind around the upper and lower sides of the ring 2. Referring to FIGS. 3 and 4, the cylindrical body 11 is configured for a magnetic core 3 to be disposed thereon. The magnetic core 3 includes a first core portion 31 and a second core portion 32 each of which has a substantially E-shaped cross section. Each of the first and second core portions 31, 32 has a central pillar 311. The central pillars 311 of the first and second core portions 31, 32 are inserted into the through hole 14 in the cylindrical body 11 via the respective ends of the cylindrical body 11 for connecting the first and second core portions 31, 32. The first and second core portions 31, 32 respectively abut against the first and second blocking members 12, 13.

Referring to FIG. 5, an air gap 33 is formed between the first and second core portions 31, 32 when assembled together. Thus, in order for the coil 10 to evade the magnetic flux leakage generated by the air gap 33 and to reduce eddy current loss due to interlinkage between the magnetic flux leakage from the air gap 33 and the coil 10, the ring 2 is sleeved onto the cylindrical body 11 and is adjusted to a position that aligns with the air gap 33 in the magnetic core 3 to form a “blocking wall” for blocking the coil 10 from the air gap 33, thereby effectively reducing eddy current loss generated due to interlinkage between the coil 10 and the magnetic flux leakage.

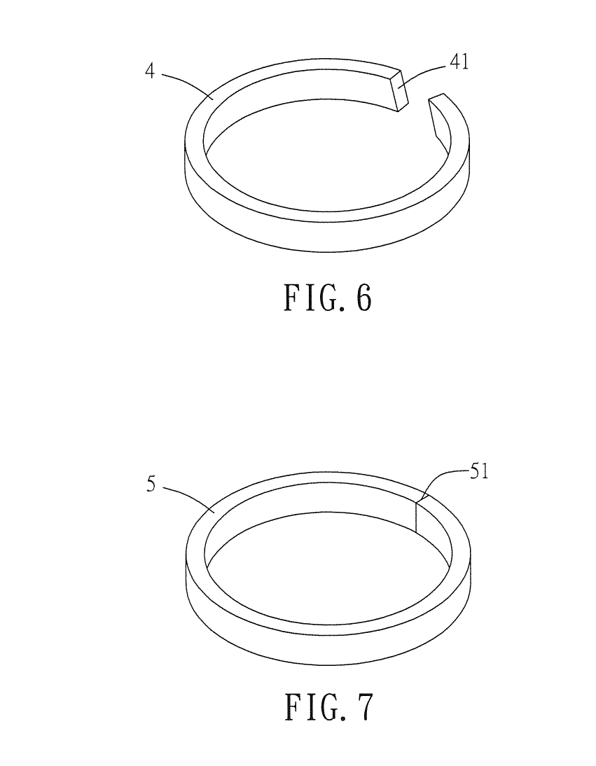

In this embodiment, the ring 2 has two opposite end surfaces 211 defining the gap 21. Each of the end surfaces 211 may be parallel to an axis of the cylindrical body 11, as shown in FIG. 1, or may be oblique to a line that is parallel to the axis of the cylindrical body 11, as shown in FIG. 6, to further facilitate passing of the coil 10 through the ring 2. As shown in FIG. 7, the ring 5 may be formed with a slit for the ring 2 to detachably sleeve onto the cylindrical body 11. In this case, the coil 10 extends over and winds around the upper and lower sides of the ring 2.

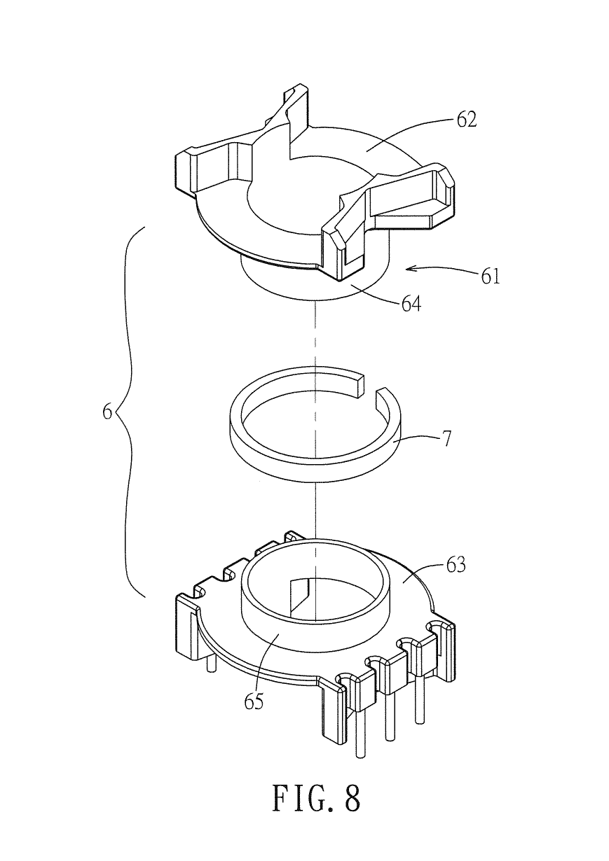

Referring to FIG. 8, a second embodiment of the bobbin structure 6 according to the disclosure is shown to be similar to the first embodiment. However, in this embodiment, the cylindrical body 61 includes first and second body port ions 64, 65 detachably assembled to each other. The first blocking portion 62 is disposed on the first body portion 64, and the second blocking portion 63 is disposed on the second body portion 65. The ring 7 is first fittingly sleeved onto one of the first and second body portions 64, 65 prior to their assembly.

Despite the ring 7 being fittingly sleeved on the cylindrical body 61, if an appropriate force is applied, the ring 7 is movable relative to the cylindrical body 61 (i.e., the ring 7 may be repositioned) so that the ring 7 maybe aligned with the air gap 33 of the magnetic core 3, thereby blocking the coil 10 wound on the cylindrical body 61 from nearing the air gap 33, and effectively reducing eddy current loss in the coil 10 caused by interlinkage between the coil 10 and the magnetic flux leakage. The ring 7 may have a gap or a slit, or may be an enclosed ring. The ring 7 may also be rigid or flexible.

In summary, due to the design of the ring 2, 4, 5, 7, being detachably sleeved on the cylindrical body 11, 61, the ring 2, 4, 5, 7 of the bobbin structure 1, 6 of the disclosure can be selectively matched with the air gap 33 (having different widths and positions) of different kinds of magnetic cores 3 disposed on the cylindrical body 11, 61 and with the amount and the diameter of the coil 10 that is wound on the cylindrical body 11, 61. Further, according to the requirement, the position of the ring 2, 4, 5, 7 on the cylindrical body 11, 61 can be adjusted, thereby increasing flexibility in use of the bobbin structure 1, 6. Hence, the bobbin structure 1, 6 of the disclosure is suitable for use with magnetic cores 3 having air gaps 33 of different widths and/or positions, and for coils 10 of different diameters to wind thereon.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A bobbin structure, comprising:
a hollow cylindrical body configured for a magnetic core to be disposed thereon and for a coil to wind thereon;
a first blocking member extending outward from one end of said cylindrical body,
a second blocking member extending outward from another end of said cylindrical body that is opposite to said one end; and
a ring sleeved onto said cylindrical body between said first and second blocking members and movable relative to said cylindrical body for repositioning.

2. The bobbin structure as claimed in claim 1, wherein said ring is detachably sleeved on said cylindrical body.

3. The bobbin structure as claimed in claim 2, wherein said ring is C-shaped and is formed with a gap for said ring to detachably sleeve onto said cylindrical body.

4. The bobbin structure as claimed in claim 3, wherein said ring has two opposite end surfaces defining said gap, and each of said end surfaces is parallel to an axis of said cylindrical body or is oblique to a line that is parallel to the axis of said cylindrical body.

5. The bobbin structure as claimed in claim 2, wherein said ring is formed with a slit for said ring to detachably sleeve onto said cylindrical body.

6. The bobbin structure as claimed in claim 1, wherein said cylindrical body includes first and second body portions detachably assembled to each other, said first blocking portion being disposed on said first body portion, said second blocking portion being disposed on said second body portion, said ring being sleeved onto one of said first and second body portions.

7. The bobbin structure as claimed in claim 1, wherein said cylindrical body is formed with a through hole that extends from said one end to said another end of said cylindrical body, the magnetic core including a first core portion and a second core portion, each of the first and second core portions having a central pillar, the central pillars of the first and second core portions being inserted into said through hole in said cylindrical body via said one end and said other end of said cylindrical body, respectively, the first and second core portions respectively abutting against said first and second blocking portions.
